(19) United States
(12) Patent Application Publication
(10) Pub. No.: US 2019/0003494 A1
(43) Pub. Date: Jan. 3, 2019

(54) HYDRAULIC DRIVING DEVICE FOR CARGO HANDLING VEHICLE

(71) Applicant: KABUSHIKI KAISHA TOYOTA JIDOSHOKKI, Kariya-shi, Aichi (JP)

(72) Inventors: Yuki UEDA, Kariya-shi (JP); Naoya YOKOMACHI, Kariya-shi (JP); Tsutomu MATSUO, Kariya-shi (JP); Takashi UNO, Kariya-shi (JP); Tetsuya GOTO, Kariya-shi (JP); Takanori KANNA, Kariya-shi (JP)

(73) Assignee: KABUSHIKI KAISHA TOYOTA JIDOSHOKKI, Kariya-shi, Aichi (JP)

(21) Appl. No.: 15/752,775

(22) PCT Filed: Aug. 18, 2016
(86) PCT No.: PCT/JP2016/074100

§ 371 Date: Feb. 14, 2018

(30) Foreign Application Priority Data
Aug. 19, 2015 (JP) 2015-161999

(51) Int. Cl. F15B 11/024; F15B 21/14; F15B 11/16; F15B 11/04

(52) U.S. Cl. CPC F15B 11/024; F15B 21/14; F15B 11/16; F15B 2211/47; F15B 2211/20515; F15B 2211/275; F15B 2211/45; F15B 11/04

(57) ABSTRACT

In a hydraulic driving device for a cargo handling vehicle, a power running torque limit value setting unit sets a power running torque limit value to a minimum rotation speed set in advance, in a case where a determination unit determines that operations of second hydraulic cylinders including a lowering operation of a first operating portion are simultaneously performed, a rotation speed command value setting unit sets a rotation speed command value to a maximum value from between a lowering required rotation speed based on an operation amount of the first operating portion and a second hydraulic cylinder required rotation speed based on operation amounts of the second operating portions, and the power running torque limit value setting unit sets the power running torque limit value to the second hydraulic cylinder required rotation speed based on the operation amounts of the second operating portions, and a control unit controls an electric motor to rotate at a rotation speed based on the rotation speed command value and controls the electric motor to rotate at a rotation speed based on the power running torque limit value in a case where an output torque of the electric motor shifts toward a power running side.

### TECHNICAL FIELD

The present invention relates to a hydraulic driving device for a cargo handling vehicle.

### BACKGROUND ART

As a hydraulic driving device for a cargo handling vehicle, for example, one described in Patent Literature 1 is known. A hydraulic driving device described in Patent Literature 1 includes a hydraulic cylinder for use in raising and lowering that raises and lowers an object by supplying and discharging a hydraulic oil, a lifting operating portion for operating the hydraulic cylinder for use in raising and lowering, a hydraulic pump that performs supply and discharge of the hydraulic oil with respect to the hydraulic cylinder for use in raising and lowering, a motor that drives the hydraulic pump, and a control valve that is disposed between a suction port of the hydraulic pump and a bottom chamber of the hydraulic cylinder for use in raising and lowering and controls the flow of the hydraulic oil based on an operation amount of a lowering operation of the raising and lowering operating portion.

### CITATION LIST

### Patent Literature

Patent Literature 1: U.S. Pat. No. 5,649,422

### SUMMARY OF INVENTION

### Technical Problem

Here, in the existing hydraulic driving device described above, the following problems are present. That is, for example, in a case where a load is heavy, the motor is allowed to function as a generator by returning the hydraulic oil discharged from the hydraulic cylinder for use in raising and lowering to the hydraulic pump mid thus electric power regeneration is performed. However, due to a configuration in which the hydraulic oil passes through a plurality of valve bodies from the hydraulic cylinder for use in raising and lowering to the hydraulic pump, the pressure loss is high and thus the regeneration efficiency is poor. Therefore, there are demands for improving the regeneration efficiency by suppressing the pressure loss of the hydraulic oil, and suppressing the power consumption.

An object of the present invention is to provide a hydraulic driving device for a cargo handling vehicle capable of improving the regeneration efficiency in a case where a load is heavy and suppressing the power consumption in a case where a load is lightweight.

### Solution to Problem

According to an aspect of the present invention, a hydraulic driving device for a cargo handling vehicle includes: a first hydraulic cylinder for use in raising and lowering that raises and lowers an object by supplying and discharging a hydraulic oil; a second hydraulic cylinder that performs a different operation from the first hydraulic cylinder by supplying and discharging the hydraulic oil; a first operating portion for operating the first hydraulic cylinder; a second operating portion for operating the second hydraulic cylinder; a hydraulic pump that supplies and discharges the hydraulic oil to and from the first hydraulic cylinder and the second hydraulic cylinder; an electric motor that is connected to the hydraulic pump and functions as a motor or a generator; a control unit that controls driving of the electric motor; a lowering oil passage that connects a bottom chamber of the first hydraulic cylinder to a suction port of the hydraulic pump so as to cause the hydraulic oil discharged from the first hydraulic cylinder to the suction port of the hydraulic pump; a first control valve that is disposed in the lowering oil passage and controls a flow of the hydraulic oil discharged from the first hydraulic cylinder based on a lowering operation of the first operating portion; a second control valve that is disposed on a pipe that connects a discharge port of the hydraulic pump to the second hydraulic cylinder and controls the flow of the hydraulic oil based on an operation of the second operating portion; a rotation speed command value setting unit that sets a rotation speed command value of the electric motor; a power running torque limit value setting unit that sets a power running torque limit value of the electric motor; and a determination unit that determines whether or not the lowering operation of the first operating portion is independently performed and whether or not the operation of the second operating portion including the lowering operation of the first operating portion is simultaneously performed, in which, in a case where the determination unit determines that the lowering operation of the first operating portion is independently performed, the rotation speed command value setting unit sets the rotation speed command value to a lowering required rotation speed based on an operation amount of the first operating portion, and the power running torque limit value setting unit sets the power running torque limit value to a minimum rotation speed set in advance, in a case where the determination unit determines that the operations of the second operating portion including the lowering operation of the first operating portion are simultaneously performed, the rotation speed command value setting unit sets the rotation speed command value to a maximum value from between the lowering required rotation speed based on the operation amount of the first operating portion and a second hydraulic cylinder required rotation speed based on an operation amount of the second operating portion, and the power running torque limit value setting unit sets the power running torque limit value to the second hydraulic cylinder required rotation speed based on the operation amount of the second operating portion, and the control unit controls the electric motor to rotate at a rotation speed based on the rotation speed command value and controls the electric motor to rotate at a rotation speed based on the power running torque limit value in a case where an output torque of the electric motor shifts toward a power running side.

In the hydraulic driving device for a cargo handling vehicle, in a case where the determination unit determines that the operation of the second operating portion including the lowering operation of the first operating portion is simultaneously performed, the rotation speed command value setting unit sets the rotation speed command value to a maximum value from between the lowering required rotation speed and a second hydraulic cylinder required rotation speed. Therefore, for example, in a case where a load is heavy, regeneration can be performed at a high rotation speed with high efficiency. On the other hand, in a case where the determination unit determines that the operation of the second operating portion including the lowering operation of the first operating portion is simultaneously performed, the power running torque limit value setting unit sets the power running torque limit value to the second hydraulic cylinder required rotation speed. Therefore, for example, in a case where the output torque of the electric motor shifts toward the power running side as the load becomes lighter, when the operation of the second operating portion is simultaneously performed, the control unit controls the electric motor to rotate at a rotation speed based on the power running torque limit value and to rotate at the rotation speed of the required lower limit for operating the second hydraulic cylinder, thereby suppressing the power consumption. From the above description, the regeneration efficiency can be improved by suppressing the pressure loss of the hydraulic oil, and the power consumption can also be suppressed.

According to another aspect of the present invention, in the hydraulic driving device for a cargo handling vehicle, the second hydraulic cylinder may include a plurality of hydraulic cylinders, and in a case where the determination unit determines that the operation of the second operating portion including the lowering operation of the first operating portion is simultaneously performed, the rotation speed command value setting unit may set the rotation speed command value to a maximum value from between the lowering required rotation speed and required rotation speeds for the plurality of hydraulic cylinders of the second hydraulic cylinder, and the power running torque limit value setting unit may set the power running torque limit value to the maximum value from between the required rotation speeds for the plurality of hydraulic cylinders of the second hydraulic cylinder. Accordingly, even in a case where the second hydraulic cylinder includes the plurality of hydraulic cylinders, the regeneration efficiency can be improved by suppressing the pressure loss of the hydraulic oil, and the power consumption can also be suppressed.

Furthermore, according to another aspect of the present invention, the hydraulic driving device for a cargo handling vehicle may further include: a bypass oil passage that connects a branch point between the first control valve in the lowering oil passage and the suction port of the hydraulic pump to a tank; and a flow rate control valve provided in the bypass oil passage, in which, by controlling the electric motor to rotate at a rotation speed based on the power running torque limit value, in a case where driving based on the rotation speed command value is not able to be achieved, the flow rate control valve may discharge the hydraulic oil to the tank via the bypass oil passage. Accordingly, unnecessary hydraulic oil can be returned to the tank.

### Advantageous Effects of Invention

According to the present invention, the regeneration efficiency can be improved by suppressing the pressure loss of the hydraulic oil, and the power consumption can also be suppressed.

### BRIEF DESCRIPTION OF DRAWINGS

FIG. 1 is a side view illustrating a cargo handling vehicle provided with a hydraulic driving device according to an embodiment of the present invention.

FIG. 2 is a hydraulic circuit diagram illustrating the hydraulic driving device according to the embodiment of the present invention.

FIG. 3 is a configuration diagram illustrating a control system of the hydraulic driving device illustrated in FIG. 2.

FIG. 4 is a block configuration diagram illustrating the control system of the hydraulic driving device illustrated in FIG. 2.

FIG. 5 is a flowchart showing control process procedures executed by a controller illustrated in FIG. 3.

FIG. 6 is a table showing a motor rotation speed command value and a power running torque limit value under each operation condition.

FIG. 7 is a diagram showing a timing chart of a motor rotation speed and a motor output torque.

### DESCRIPTION OF EMBODIMENTS

Hereinafter, preferred embodiments of a hydraulic driving device for a cargo handling vehicle according to the present invention will be described in detail with reference to the drawings. In the drawings, like elements which are the same or equivalent to each other are denoted by like reference numerals, and redundant description will be omitted.

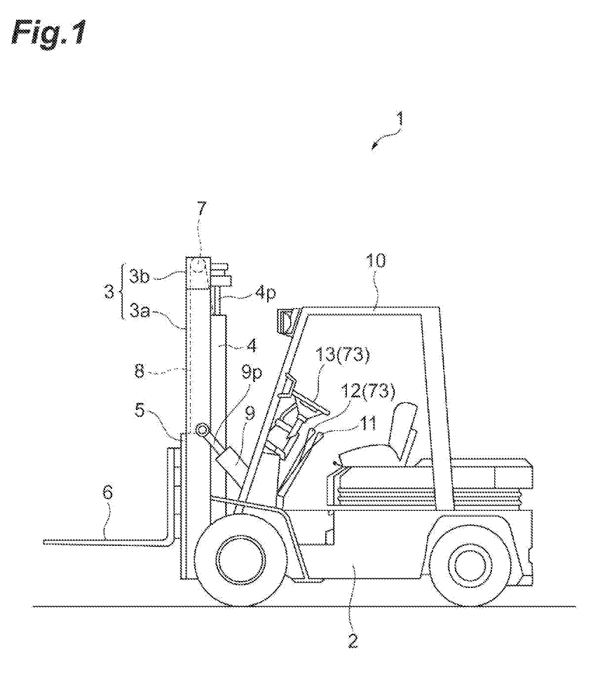

FIG. 1 is a side view illustrating the cargo handling vehicle provided with the hydraulic driving device according to the embodiments of the present invention. In the figure, a cargo handling vehicle 1 according to this embodiment is a battery type forklift. The cargo handling vehicle 1 includes a vehicle body frame 2 and a mast 3 disposed at the front portion of the vehicle body frame 2. The mast 3 is constituted of a pair of right and left outer masts 3a tiltably supported by the vehicle body frame 2, and an inner mast 3b that is disposed inside the outer masts 3a to be raised and lowered with respect to the outer masts 3a.

A lift cylinder 4 as a hydraulic cylinder for use in raising and lowering is disposed on the rear side of the mast 3. The tip end portion of a piston rod 4p of the lift cylinder 4 is connected to the upper portion of the inner mast 3b.

A lift bracket 5 is supported on the inner mast 3b to be raised and lowered. A fork (object) 6 on which a load is loaded is attached to the lift bracket 5. A chain wheel 7 is provided in the upper portion of the inner mast 3b, and a chain 8 is hung on the chain wheel 7. One end portion of the chain 8 is connected to the lift cylinder 4, and the other end portion of the chain 8 is connected to the lift bracket 5. When the lift cylinder 4 is extended and retracted, the fork 6 is raised and lowered together with the lift bracket 5 via the chain 8.

Tilt cylinders 9 as tilting hydraulic cylinders are respectively supported on both the right and left sides of the vehicle body frame 2. The tip end portion of a piston rod 9p of the tilt cylinder 9 is rotatably connected to the substantially center portion of the outer mast 3a in the height direction. When the tilt cylinder 9 is extended and retracted, the mast 3 is tilted.

A cab 10 is provided on the vehicle body frame 2. In the front portion of the cab 10, a lift operating lever 11 for raising and lowering the fork 6 by operating the lift cylinder 4, and a tilt operating lever 12 for tilting the mast 3 by operating the tilt cylinder 9.

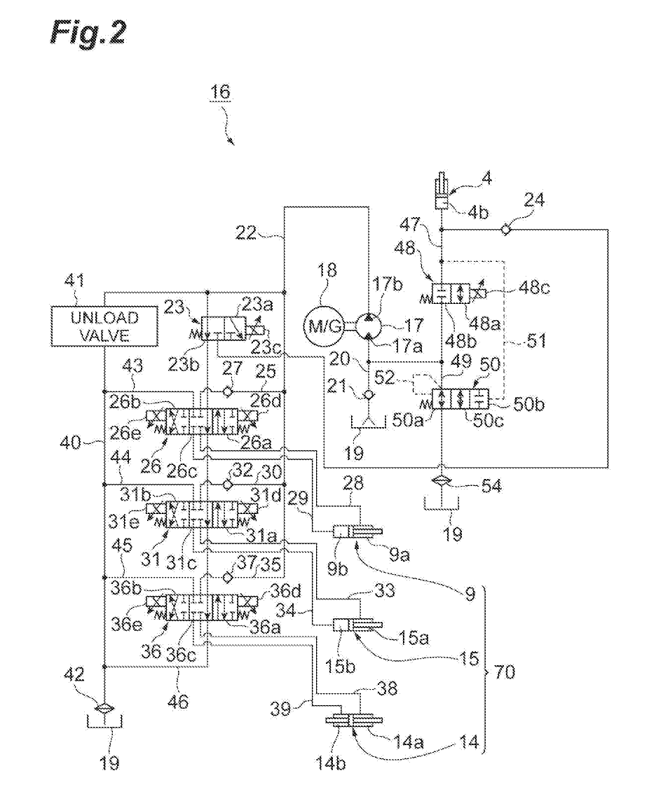

In the front portion of the cab 10, a steering 13 for steering is provided. The steering 13 is a hydraulic power steering, and it is possible to assist steering of an operator by a PS cylinder 14 (see FIG. 2) as a power steering (PS) hydraulic cylinder.

In addition, the cargo handling vehicle 1 includes an attachment cylinder 15 (see FIG. 2) as an attachment hydraulic cylinder that operates an attachment (not illustrated). Examples of the attachment include those that horizontally move, tilt, and rotate the fork 6. In addition, in the cab 10, an attachment operating lever (not illustrated) for operating the attachment by operating the attachment cylinder 15 is provided.

Furthermore, although not particularly illustrated, in the cab 10, a direction switch for switching between the traveling directions (forward/reverse/neutral) of the cargo handling vehicle 1 is provided.

FIG. 2 is a hydraulic circuit diagram illustrating the first embodiment of the hydraulic driving device according to the present invention. In the figure, a hydraulic driving device 16 of this embodiment is a device that drives the lift cylinder 4, the tilt cylinder 9, the attachment cylinder 15, and the PS cylinder 14.

The hydraulic driving device 16 includes a single hydraulic pump motor 17, and a single electric motor 18 that drives the hydraulic pump motor 17. The hydraulic pump motor 17 has a suction port 17a for suctioning the hydraulic oil, and a discharge port 17b for discharging the hydraulic oil. The hydraulic pump motor 17 is configured to rotate in one direction.

The electric motor 18 functions as a motor or a generator. Specifically, in a case where the hydraulic pump motor 17 is operated as a hydraulic pump, the electric motor 18 functions as the motor, and in a case where the hydraulic pump motor 17 is operated as a hydraulic motor, the electric motor 18 functions as the generator. When the electric motor 18 functions as the generator, electric power generated by the electric motor 18 is stored in a battery (not illustrated). That is, a regeneration operation is performed.

A tank 19 that stores the hydraulic oil is connected to the suction port 17a of the hydraulic pump motor 17 via a hydraulic pipe 20. A check valve 21 that allows the hydraulic oil to flow only in the direction from the tank 19 to the hydraulic pump motor 17 is provided in the hydraulic pipe 20. The hydraulic pump motor 17 functions as a pump that supplies the hydraulic oil to the lift cylinder 4 during a raising operation by the lift operating lever 11, and functions as a hydraulic motor driven by the hydraulic oil discharged from the lift cylinder 4 during the lowering operation by the lift operating lever 11.

The discharge port 17b of the hydraulic pump motor 17 and a bottom chamber 4b of the lift cylinder 4 are connected via a hydraulic pipe 22. A lift raising solenoid proportional valve 23 is disposed in the hydraulic pipe 22. The solenoid proportional valve 23 is switched between an open position 23a where the flow of the hydraulic oil from the hydraulic pump motor 17 to the bottom chamber 4b of the lift cylinder 4 is allowed, and a closed position 23b where the flow of the hydraulic oil from the hydraulic pump motor 17 to the bottom chamber 4b of the lift cylinder 4 is blocked.

The solenoid proportional valve 23 is normally in the closed position 23b (illustrated) and is switched to the open position 23a when an operating signal (a lift raising solenoid current command value corresponding to an operation amount of the raising operation of the lift operating lever 11) is input to a solenoid operating portion 23c. Then, the hydraulic oil is supplied from the hydraulic pump motor 17 to the bottom chamber 4b of the lift cylinder 4 such that the lift cylinder 4 is extended and thus the fork 6 is raised. In addition, the solenoid proportional valve 23 is opened at an opening degree corresponding to the operating signal in the open position 23a. A check valve 24 that allows the hydraulic oil to flow only in the direction from the solenoid proportional valve 23 to the lift cylinder 4 is provided between the solenoid proportional valve 23 and the lift cylinder 4 in the hydraulic pipe 22.

A tilt solenoid proportional valve 26 is connected to the branch point between the hydraulic pump motor 17 and the solenoid proportional valve 23 in the hydraulic pipe 22 via a hydraulic pipe 25. A check valve 27 that allows the hydraulic oil to flow only in the direction from the hydraulic pump motor 17 to the solenoid proportional valve 26 is provided in the hydraulic pipe 25.

The solenoid proportional valve 26 is connected to a rod chamber 9a and a bottom chamber 9b of the tilt cylinder 9 via hydraulic pipes 28 and 29, respectively. The solenoid proportional valve 26 is switched among an open position 26a where the flow of the hydraulic oil from the hydraulic pump motor 17 to the rod chamber 9a of the tilt cylinder 9 is allowed, an open position 26b where the flow of the hydraulic oil from the hydraulic pump motor 17 to the bottom chamber 9b of the tilt cylinder 9 is allowed, and a closed position 26c where the flow of the hydraulic oil from the hydraulic pump motor 17 to the tilt cylinder 9 is blocked.

The solenoid proportional valve 26 is normally in the closed position 26c (illustrated), is switched to the open position 26a when an operating signal (a tilt solenoid current command value corresponding to an operation amount of a rearward tilting operation of the tilt operating lever 12) is input to a solenoid operating portion 26d on the open position 26a side, and is switched to the open position 26b when an operating signal (a tilt solenoid current command value corresponding to an operation amount of a forward tilting operation of the tilt operating lever 12) is input to a solenoid operating portion 26e on the open position 26b side. When the solenoid proportional valve 26 is switched to the open position 26a, the hydraulic oil is supplied to the rod chamber 9a of the tilt cylinder 9 from the hydraulic pump motor 17. Therefore, the tilt cylinder 9 is retracted and thus the mast 3 is tilted rearward. When the solenoid proportional valve 26 is switched to the open position 26b, the hydraulic oil is supplied to the bottom chamber 9b of the tilt cylinder 9 from the hydraulic pump motor 17. Therefore, the tilt cylinder 9 is extended and thus the mast 3 is tilted forward. In addition, the solenoid proportional valve 26 is opened at opening degrees corresponding to the operating signals in the open positions 26a and 26b.

An attachment solenoid proportional valve 31 is connected to the upstream side of the check valve 27 in the hydraulic pipe 25 via a hydraulic pipe 30. A check valve 32 that allows the hydraulic oil to flow only in the direction from the hydraulic pump motor 17 to the solenoid proportional valve 31 is provided in the hydraulic pipe 30.

The solenoid proportional valve 31 is connected to a rod chamber 15a and a bottom chamber 15b of the attachment cylinder 15 via hydraulic pipes 33 and 34, respectively. The solenoid proportional valve 31 is switched among an open position 31a where the flow of the hydraulic oil from the hydraulic pump motor 17 to the rod chamber 15a of the attachment cylinder 15 is allowed, an open position 31b where the flow of the hydraulic oil from the hydraulic pump motor 17 to the bottom chamber 15b of the attachment cylinder 15 is allowed, and a closed position 31c where the flow of the hydraulic oil from the hydraulic pump motor 17 to the attachment cylinder 15 is blocked.

The solenoid proportional valve 31 is normally in the closed position 31c (illustrated), is switched to the open position 31a when an operating signal (an attachment solenoid current command value corresponding to an operation amount of one side operation of an attachment operating lever) is input to a solenoid operating portion 31d on the open position 31a side, and is switched to the open position 31b when an operating signal (an attachment solenoid current command value corresponding to an operation amount of the other side operation of the attachment operating lever) is input to a solenoid operating portion 31e on the open position 31b side. The operation of the attachment cylinder 15 will be omitted. In addition, the solenoid proportional valve 31 is opened at opening degrees corresponding to the operating signals in the open positions 31a and 31b.

A PS solenoid proportional valve 36 is connected to the upstream side of the check valve 32 in the hydraulic pipe 30 via a hydraulic pipe 35. A check valve 37 that allows the hydraulic oil to flow only in the direction from the hydraulic pump motor 17 to the solenoid proportional valve 36 is provided in the hydraulic pipe 35.

The solenoid proportional valve 36 is connected to a first rod chamber 14a and a second rod chamber 14b of the PS cylinder 14 via hydraulic pipes 38 and 39, respectively. The solenoid proportional valve 36 is switched among an open position 36a where the flow of the hydraulic oil from the hydraulic pump motor 17 to the first rod chamber 14a of the PS cylinder 14 is allowed, an open position 36b where the flow of the hydraulic oil from the hydraulic pump motor 17 to the second rod chamber 14b of the PS cylinder 14 is allowed, and a closed position 36c where the flow of the hydraulic oil from the hydraulic pump motor 17 to the PS cylinder 14 is blocked.

The solenoid proportional valve 36 is normally in the closed position 36c (illustrated), is switched to the open position 36a when an operating signal (a PS solenoid current command value corresponding to an operation speed of one of right and left side operations of the steering 13) is input to a solenoid operating portion 36d on the open position 36a side, and is switched to the open position 36b when an operating signal (a PS solenoid current command value corresponding to an operation speed of the other of the right and left side operations of the steering 13) is input to a solenoid operating portion 36e on the open position 36b side. The operation of the PS cylinder 14 will be omitted. In addition, the solenoid proportional valve 36 is opened at opening degrees corresponding to the operating signals in the open positions 36a and 36b.

The branch point between the hydraulic pump motor 17 and the solenoid proportional valve 23 in the hydraulic pipe 22 is connected to the tank 19 via a hydraulic pipe 40. An unload valve 41 and a filter 42 are provided in the hydraulic pipe 40. The hydraulic pipe 40 is connected to the solenoid proportional valves 26, 31, and 36 via the hydraulic pipes 43 to 45, respectively. Furthermore, the solenoid proportional valves 23, 26, 31, and 36 are connected to the hydraulic pipe 40 via a hydraulic pipe 46.

The suction port 17a of the hydraulic pump motor 17 and the bottom chamber 4b of the lift cylinder 4 are connected via a hydraulic pipe (lowering oil passage) 47. The hydraulic pipe 47 connects the bottom chamber 4b of the lift cylinder 4 to the suction port 17a of the hydraulic pump motor 17 so as to cause the hydraulic oil discharged from the lift cylinder 4 to flow to the suction port 17a of the hydraulic pump motor 17 during an independent lowering operation by the lift operating lever 11. A lift lowering solenoid proportional valve (first control valve) 48 is disposed in the hydraulic pipe 47. The solenoid proportional valve 48 is switched between an open position 48a where the flow of the hydraulic oil from the bottom chamber 4b of the lift cylinder 4 to the suction port 17a of the hydraulic pump motor 17 is allowed, and a closed position 48b where the flow of the hydraulic oil from the bottom chamber 4b of the lift cylinder 4 to the suction port 17a of the hydraulic pump motor 17 is blocked.

The solenoid proportional valve 48 is normally in the closed position 48b (illustrated) and is switched to the open position 48a when an operating signal (a lift lowering solenoid current command value corresponding to an operation amount of the lowering operation of the lift operating lever 11) is input to a solenoid operating portion 48c. Then, the fork 6 is lowered due to the own weight of the fork 6, and thus the lift cylinder 4 is retracted. Therefore, the hydraulic oil flows out from the bottom chamber 4b of the lift cylinder 4. In addition, the solenoid proportional valve 48 is opened at an opening degree corresponding to the operating signal in the open position 48a.

The branch point between the hydraulic pump motor 17 and the solenoid proportional valve 48 in the hydraulic pipe 47 is connected to the tank 19 via a hydraulic pipe (bypass oil passage) 49. A pressure compensation valve (flow rate control valve) 50 is disposed in the hydraulic pipe 49. The pressure compensation valve 50 is a flow rate control valve with a pressure compensation function. In addition, a filter 54 is provided in the hydraulic pipe 49.

The pressure compensation valve 50 is switched among an open position 50a where the flow of the hydraulic oil is allowed, a closed position 50b where the flow of the hydraulic oil is blocked, and a throttle position 50c where the flow rate of the hydraulic oil is adjusted. A pilot operating portion on the closed position 50b side of the pressure compensation valve 50 and the upstream side (front side) of the solenoid proportional valve 48 are connected via a pilot flow passage 51. A pilot operating portion on the open position 50a side of the pressure compensation valve 50 and the downstream side (rear side) of the solenoid proportional valve 48 are connected via a pilot flow passage 52. The pressure compensation valve 50 is opened at an opening degree corresponding to the pressure difference across the solenoid proportional valve 48. Specifically, the pressure compensation valve 50 is normally in the closed position (illustrated). In addition, the opening degree of the pressure compensation valve 50 decreases as the pressure difference across the solenoid proportional valve 48 increases.

Among the cylinders described above, the tilt cylinder 9, the attachment cylinder 15, and the PS cylinder 14, which perform different operations from the lift cylinder (first hydraulic cylinder) 4 by supplying and discharging the hydraulic oil, may be collectively referred to as “second hydraulic cylinders 70”. The tilt operating lever 12, the steering 13, and the attachment operating lever for operating the second hydraulic cylinders 70 may be collectively referred to as “second operating portions 73”.

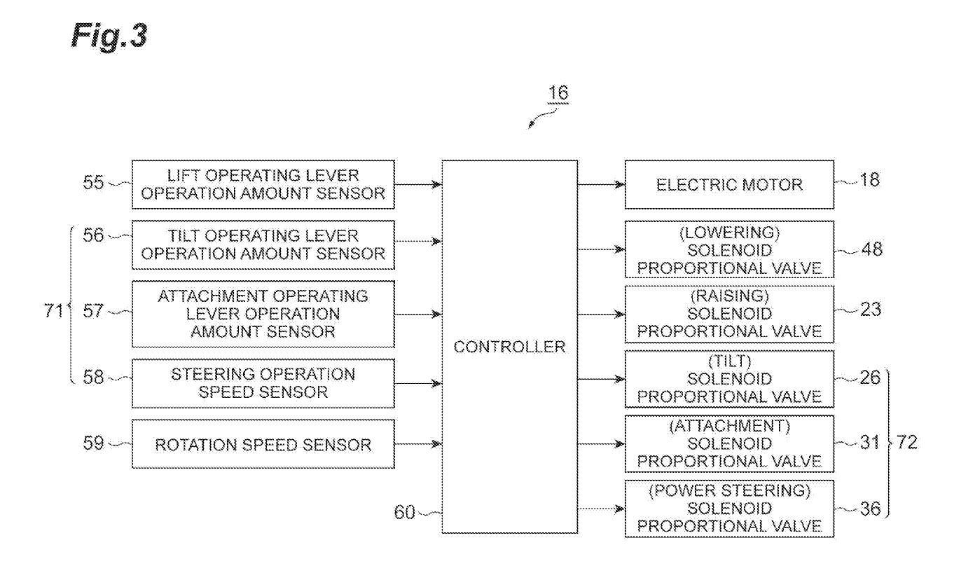

FIG. 3 is a configuration diagram illustrating a control system of the hydraulic driving device 16. In the figure, the hydraulic driving device 16 includes a lift operating lever operation amount sensor (operation amount detection unit) 55 that detects the operation amount of the lift operating lever 11, a tilt operating lever operation amount sensor 56 that detects the operation amount of the tilt operating lever 12, an attachment operating lever operation amount sensor 57 that detects the operation amount of the attachment operating lever (not illustrated), a steering operation speed sensor 58 that detects the operation speed of the steering 13, a rotation speed sensor 59 that detects the actual rotation speed (motor actual rotation speed) of the electric motor 18, and a controller 60.

The controller 60 receives the detection values of the operating lever operation amount sensors 55 to 57, the steering operation speed sensor 58, and the rotation speed sensor 59, performs predetermined processes, and controls the electric motor 18 and the solenoid proportional valves 23, 26, 31, 36, and 48. In addition, the sensors 56, 57, and 58 that detect the operation amounts of the second operating portions 73 may be referred to as “second operation amount detection units 71”. In addition, the solenoid proportional valves 26, 31, and 36 that are disposed between the discharge port 17b of the hydraulic pump motor 17 and the second hydraulic cylinders to control the flow of the hydraulic oil based on the operations of the second operating portions may be referred to as “second control valves 72”.

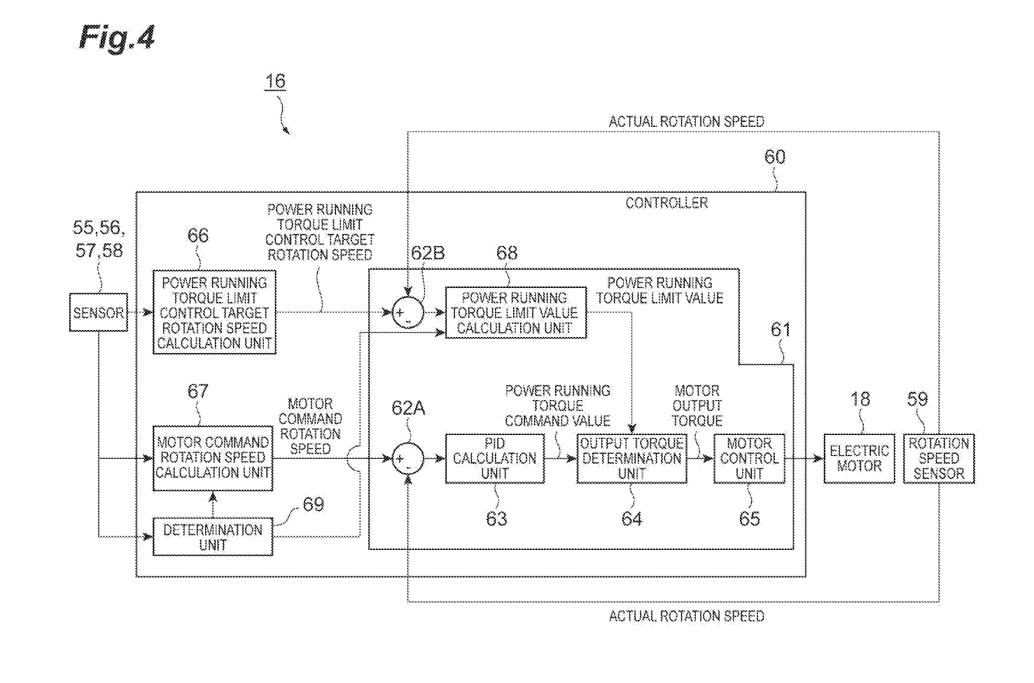

FIG. 4 is a block configuration diagram illustrating a block configuration of the control system of the hydraulic driving device 16. As illustrated in FIG. 4, the controller 60 includes a motor driver 61, a power running torque limit control target rotation speed calculation unit 66, a motor command rotation speed calculation unit 67, and a determination unit 69.

The motor driver 61 includes comparison units 62A and 62B, a PID calculation unit 63, a power running torque limit value calculation unit 68, an output torque determination unit (control unit) 64, and a motor control unit (control unit) 65. The comparison unit 62A calculates a rotation speed deviation between a motor command rotation speed set by the motor command rotation speed calculation unit 67 and the motor actual rotation speed detected by the rotation speed sensor 59. The comparison unit 62B calculates a rotation speed deviation between a power running torque limit control target rotation speed set by the power running torque limit control target rotation speed calculation unit 66 and the motor actual rotation speed detected by the rotation speed sensor 59. The PID calculation unit 63 performs a PID calculation on the rotation speed deviation between the motor command rotation speed arid the motor actual rotation speed, and obtains a power running torque command value of the electric motor 18 so as to cause the rotation speed deviation to become zero. The PID calculation is a calculation of a combination of a proportional operation, an integral operation, and a derivative operation. The power running torque limit value calculation unit 68 calculates and sets a power running torque limit value of the electric motor 18 based on the rotation speed deviation between the power running torque limit control target rotation speed and the motor actual rotation speed detected by the rotation speed sensor 59. The power running torque limit value is a value for, in a case where an output torque of the electric motor 18 shifts toward the power running side, limiting an increase in the output torque. In addition, the power running torque limit value set by the power running torque limit value calculation unit 68 will he described in detail.

The output torque determination unit 64 and the motor control unit 65 constituting the control unit control the electric motor 18 to rotate at a rotation speed based on the motor command rotation speed (rotation speed command value) and control the electric motor 18 to rotate at a rotation speed based on the power running torque limit value in a case where the output torque of the electric motor 18 shifts toward the power running side. The output torque determination unit 64 compares the power running torque command value (a value based on the motor command rotation speed) obtained by the PID calculation unit 63 to the power running torque limit value of the electric motor 18 set by the power running torque limit value calculation unit 68 and determines the output torque of the electric motor 18. Specifically, when the power running torque command value is equal to or lower than the power running torque limit value, the output torque determination unit 64 sets the output torque of the electric motor 18 to the power running torque command value. When the power running torque command value is higher than the power running torque limit value, the output torque determination unit 64 sets the output torque of the electric motor 18 to the power running torque limit value. The motor control unit 65 converts the output torque determined by the output torque determination unit 64 into a current signal and transmits the current signal to the electric motor 18. In addition, by controlling the electric motor 18 to rotate at a rotation speed based on the power running torque limit value, in a case where driving based on the motor command rotation speed cannot be achieved, the pressure compensation valve 50 discharges the hydraulic oil to the tank 19 via the hydraulic pipe 49.

The motor command rotation speed calculation unit 67 acquires a detection value detected by each of the sensors 55, 56, 57, and 58 and sets the motor command rotation speed (rotation speed command value) based on the detection values. The motor command rotation speed calculation unit 67 sets the motor command rotation speed according to the operation amount of each of the operating levers. In addition, the motor command rotation speed set by the motor command rotation speed calculation unit 67 will be described in detail. The power running torque limit control target rotation speed calculation unit 66 acquires the detection value detected by each of the sensors 55, 56, 57, and 58 and sets the power running torque limit control target rotation speed based on the detection values. The power running torque limit control target rotation speed calculation unit 66 sets the power running torque limit control target rotation speed according to an operation state of each of the operating levers.

The determination unit 69 determines whether or not the lowering operation of the lift operating lever 11 is independently performed and whether or not the operations of the second operating portions 73 including the lowering operation of the lift operating lever 11 are simultaneously performed. For example, in the case of “lift lowering+tilt operations”, “lift lowering+attachment operations”, “lift lowering+power steering operations”, “lift lowering+tilt+power steering operations”, the determination unit 69 determines that the operations of the second operating portions 73 including the lift operating lever 11 are simultaneously performed. The determination unit 69 outputs the determination result to the motor command rotation speed calculation unit 67 and the power running torque limit value calculation unit 68.

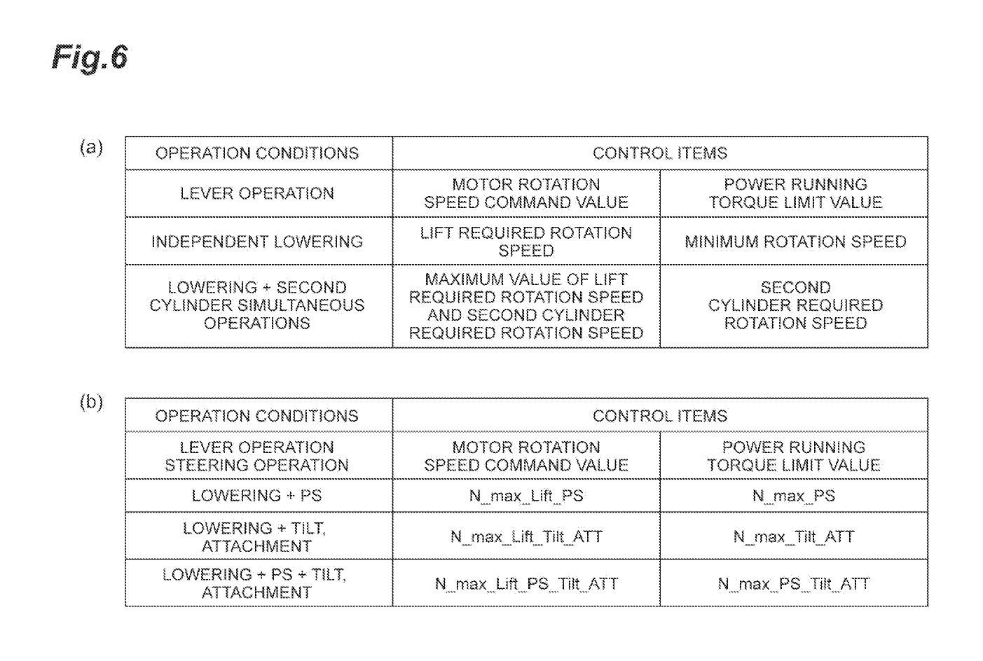

As shown in FIG. 6(a), in a case where the determination unit 69 determines that the lowering operation of the lift operating lever 11 is independently performed, the motor command rotation speed calculation unit 67 sets the motor command rotation speed (rotation speed command value) to a lowering required rotation speed. In addition, the power running torque limit value calculation unit 68 sets the power running torque limit value to a minimum rotation speed set in advance. The minimum rotation speed is determined according to the specification and the like of the pump or the motor, and is set to 0 rpm or a value closed to 0 rpm.

As illustrated in FIG. 6(a), in a case where the determination unit 69 determines that the operations of the second operating portions 73 including the lowering operation of the lift operating lever 11 are simultaneously performed, the motor command rotation speed calculation unit 67 sets the motor command rotation speed to a maximum value from between the lowering required rotation speed and a second hydraulic cylinder required rotation speed, and the power running torque limit value calculation unit 68 sets the power running torque limit value to the second hydraulic cylinder required rotation speed.

Specifically, as shown in FIG. 6(b), in a case where it is determined that the “lift lowering+power steering operations” are performed, the motor command rotation speed calculation unit 67 sets the motor command rotation speed to a maximum value (N_max_Lift_PS) from between the lowering required rotation speed and a PS required rotation speed, and the power running torque limit value calculation unit 68 sets the power running torque limit value to the PS required rotation speed (N_max_PS). In a case where it is determined that the “lift lowering+tilt operations” or the “lift lowering+attachment operations” are performed, the motor command rotation speed calculation unit 67 sets the motor command rotation speed to a maximum value (N_max_Lift_Tilt_ATT) from between the lowering required rotation speed, a tilt required rotation speed, and an attachment required rotation speed, and the power running torque limit value calculation unit 68 sets the power running torque limit value to the tilt required rotation speed and the attachment required rotation speed (N_max_Tilt_ATT). In a case where it is determined that the “lift lowering+tilt+power steering operations” or the “lift lowering+attachment operation+power steering operation” are performed, the motor command rotation speed calculation unit 67 sets the motor command rotation speed to a maximum value (N_max_Lift_PS_Tilt_ATT) from between the lowering required rotation speed, the tilt required rotation speed, the attachment required rotation speed, and the power steering required rotation speed, and the power running torque limit value calculation unit 68 sets the power running torque limit value to a maximum value (N_max_PS_Tilt_ATT) from between the tilt required rotation speed, the attachment required rotation speed, and the PS required rotation speed.

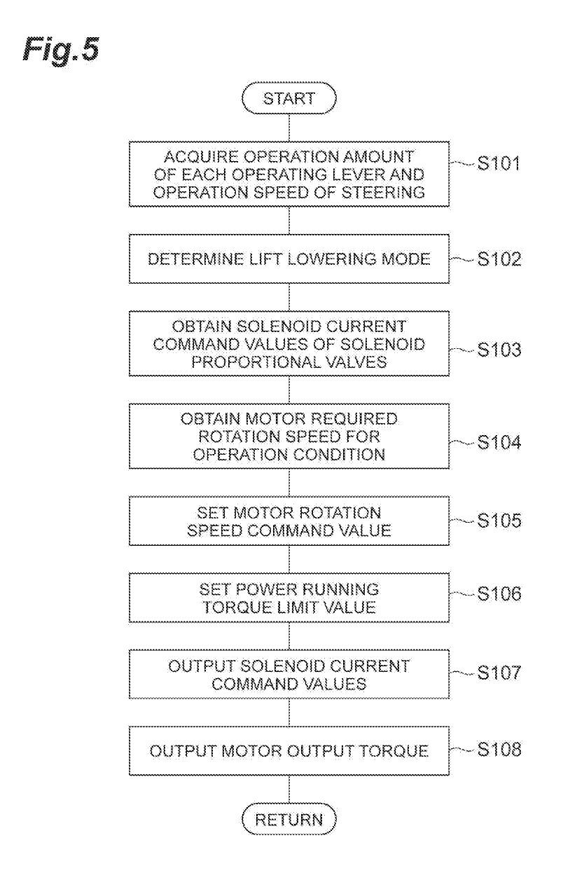

FIG. 5 is a flowchart showing control process procedures executed by the controller 60. In this control process, only the operation including the lowering the fork 6 (lift lowering) is targeted. In addition, the cycle of executing this control process is appropriately determined by an experiment or the like.

In the figure, the controller 60 first acquires the operation amounts of the lift operating lever 11, the tilt operating lever 12, and the attachment operating lever detected by the operating lever operation amount sensors 55 to 57 and the operation speed of the steering 13 detected by the steering operation speed sensor 58 (procedure S101).

Subsequently, based on the operation amounts of the lift operating lever 11, the tilt operating lever 12, and the attachment operating lever and the operation speed of the steering 13 acquired in procedure S101, the controller 60 determines a lift lowering mode as an operation condition (procedure S102). As the lift lowering mode, there are an “independent lift lowering operation”, the “lift lowering+tilt operations”, the “lift lowering+attachment operations”, the “lift lowering+power steering operations”, and the “lift lowering+tilt+power steering operations”.

Subsequently, the controller 60 obtains solenoid current command values of the solenoid proportional valves corresponding to the operation amounts of the lift operating lever 11, the tilt operating lever 12, and the attachment operating lever and the operation speed of the steering 13 acquired in procedure S101, and the lift lowering mode determined in procedure S102 (procedure S103). As the solenoid current command values of the solenoid proportional valves, there are a lift lowering solenoid current command value corresponding to the operation amount of the lowering operation of the lift operating lever 11, a tilt solenoid current command value corresponding to the operation amount of the tilt operating lever 12, an attachment solenoid current command value corresponding to the operation amount of the attachment operating lever, and a power steering (PS) solenoid current command value corresponding to the operation speed of the steering 13.

Subsequently, the controller 60 obtains a required rotation speed for the operation condition obtained in procedure S102 (procedure S104). As the required rotation speed, there are a lift required motor rotation speed, a tilt required motor rotation speed, an attachment required motor rotation speed, and a power steering (PS) required motor rotation speed. The lift required motor rotation speed is the rotation speed of the electric motor 18 required to perform the lift operation. The tilt required motor rotation speed is the rotation speed of the electric motor 18 required to perform the tilt operation. The attachment required motor rotation speed is the rotation speed of the electric motor 18 required to perform the attachment operation. The PS required motor rotation speed is the rotation speed of the electric motor 18 required to perform the PS operation.

Subsequently, the motor command rotation speed calculation unit 67 sets a motor rotation speed command value (motor command rotation speed) based on the lift lowering mode determined in procedure S102 and the required rotation speed obtained in procedure S104 (procedure S105). At this time, the motor command rotation speed is set based on FIG. 6 described above.

Subsequently, the controller 60 sets the power running torque limit value of the electric motor 18 based on the lift lowering mode determined in procedure S102 (procedure S106). The power running torque limit value is an allowable power running torque value. At this time, the power running torque limit value is set based on FIG. 6 described above.

After executing procedure S107, the controller 60 transmits the solenoid current command values of the solenoid proportional valves obtained in procedure S103 to the corresponding solenoid operating portion of the solenoid proportional valve (procedure S107). At this time, the controller 60 transmits the lift lowering solenoid current command value to the solenoid operating portion 48c of the solenoid proportional valve 48. In addition, the controller 60 transmits, when the tilt solenoid current command value is obtained, the current command value to any of the solenoid operating portions 26d and 26e of the solenoid proportional valve 26, transmits, when the attachment solenoid current command value is obtained, the current command value to any of the solenoid operating portions 31d and 31e of the solenoid proportional valve 31, and transmits, when the PS solenoid current command value is obtained, the current command value of any of the solenoid operating portions 36d and 36e of the solenoid proportional valve 36.

Subsequently, the controller 60 obtains the output torque of the electric motor 18 based on the motor rotation speed command value (motor command rotation speed) set in procedure S105, the motor actual rotation speed detected by the rotation speed sensor 59, and the power running torque limit value of the electric motor 18 set in procedure S106, and transmits the output torque to the electric motor 18 as a control signal (procedure S108). The process of procedure S108 is executed by the motor driver 61 included in the controller 60 as shown in FIG. 4.

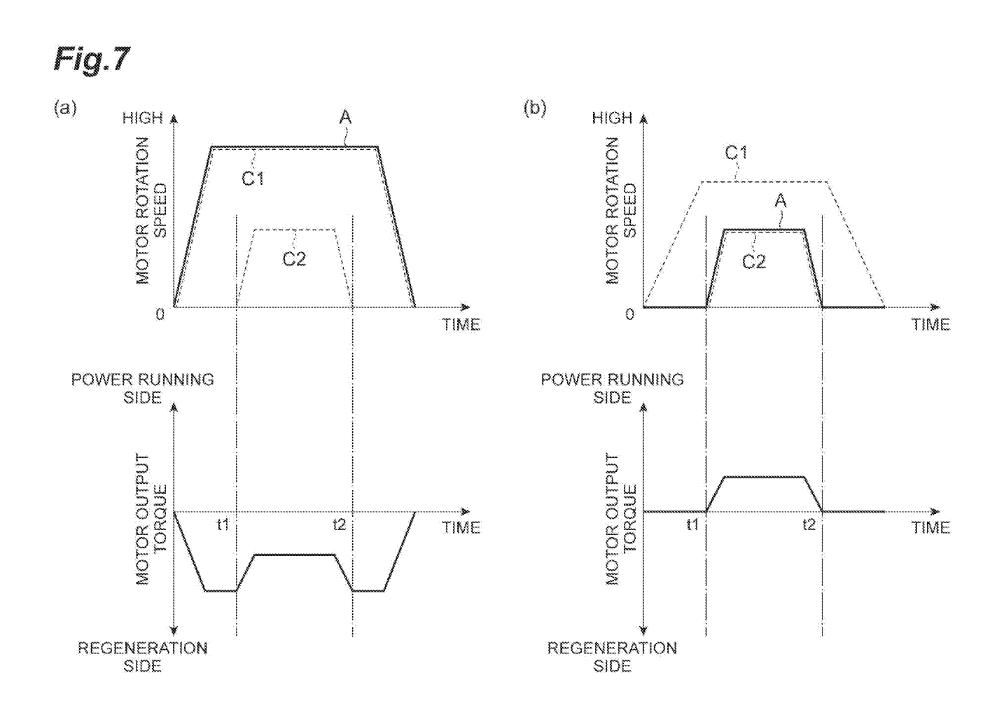

Next, the operations of the hydraulic driving device 16 of this embodiment will be described with reference to FIG. 7. FIG. 7(a) is a diagram showing a timing chart in a case where the lift lowering operation is performed in a state in which a load is large (high load state). In the state of FIG. 7(a), sufficient regeneration can be performed. FIG. 7(b) is a diagram showing a timing chart in a case where the lift lowering operation is performed in a state in which a load is small (low load state). In the state of FIG. 7(b), sufficient regeneration cannot be performed. In the upper parts of FIGS. 7(a) and 7(b), a graph C1 representing the lowering required rotation speed is indicated by broken line, and a graph C2 representing the second hydraulic cylinder required rotation speed is indicated by broken line. The graph C2 rises at time t1 and becomes zero at time t2. A graph A indicated by solid line represents the actual rotation speed.

First, as shown in FIG. 7, the lift lowering operation is independently performed from a start to time t1. Therefore, the motor command rotation speed calculation unit 67 sets the motor command rotation speed to the lowering required rotation speed (the graph C1). In addition, the power running torque limit value calculation unit 68 sets the power running torque limit value to the minimum rotation speed set in advance (here, 0 rpm). The operations of the second operating portions 73 including the lift lowering operation are simultaneously performed from time t1 to time t2. Therefore, the motor command rotation speed calculation unit 67 sets the motor command rotation speed to the maximum value from between the lowering required rotation speed and the second hydraulic cylinder required rotation speed (here, the graph C1 of the lowering required rotation speed), and the power running torque limit value calculation unit 68 sets the power running torque limit value to the second hydraulic cylinder required rotation speed (graph C2). In addition, the lift lowering operation is independently performed after time t2. Therefore, the motor command rotation speed calculation unit 67 sets the motor command rotation speed to the lowering required rotation speed (graph C1). In addition, the power running torque limit value calculation unit 68 sets the power running torque limit value to the minimum rotation speed set in advance (here, 0 rpm).

In the high load state shown in FIG. 7(a), the lift lowering operation is independently performed from the start to time t1, regeneration can be sufficiently performed, and thus the motor output torque shifts toward the regeneration side. Therefore, the actual rotation speed (graph A) becomes equal to the lowering required rotation speed (graph C1) without receiving a power running torque limit. Since sufficient regeneration can be performed from time t1 to time t2, the motor output torque shifts toward the power running side by the operation amounts of the second hydraulic cylinders. Therefore, the actual rotation speed (graph A) becomes equal to the lowering required rotation speed (graph C1) without receiving the power running torque limit. After time t2, the lift lowering operation is independently performed, regeneration can be sufficiently performed, and thus the motor output torque shifts toward the regeneration side. Therefore, the actual rotation speed (graph A) becomes equal to the lowering required rotation speed (graph C1) without receiving the power running torque limit.

In the low load state shown in FIG. 7(b), regeneration cannot be sufficiently performed. Therefore, the power running torque limit is applied so as not to cause the motor output torque to shift toward the power running side between the start to time t1. Therefore, by receiving the power running torque limit (the power running torque limit value is 0 rpm), the actual rotation speed (graph A) becomes 0 rpm. Sufficient regeneration cannot be performed from time t1 to time t2. However, since the power running torque limit value is the second hydraulic cylinder required rotation speed (graph C2), the actual rotation speed (graph A) becomes equal to the second hydraulic cylinder required rotation speed (graph C2), and accordingly, the motor output torque shifts toward the power running side. After t2, the power running torque limit is applied so as not to cause the motor output torque to shift toward the power running side. Therefore, by receiving the power running torque limit (the power running torque limit value is 0 rpm), the actual rotation speed (graph A) becomes 0 rpm.

In addition, in a case where the actual rotation speed is lower than the lowering required rotation speed, the flow rate of the shortage is compensated by the pressure compensation valve 50 and the pilot flow passage 51. Furthermore, in a case where the actual rotation speed is higher than the second hydraulic cylinder required rotation speed, the excess is bypassed by the unload valve 41 to flow to the tank 19, and thus it becomes possible to perform a stable operation.

Next, the operations and effects of the hydraulic driving device 16 for the cargo handling vehicle 1 according to this embodiment will be described.

In the hydraulic driving device 16 for the cargo handling vehicle 1 according to this embodiment, in a case where the determination unit 69 determines that the operations of the second operating portions 73 including the lowering operation of the lift operating lever 11 are simultaneously performed, the motor command rotation speed calculation unit 67 sets the rotation speed command value to the maximum value from between the lowering required rotation speed and the second hydraulic cylinder required rotation speed. Therefore, in a case where a load is heavy, regeneration can be performed at a high rotation speed with high efficiency. On the other hand, in a case where the determination unit 69 determines that the operations of the second operating portions 73 including the lowering operation of the lift operating lever 11 are simultaneously performed, the power running torque limit value calculation unit 68 sets the power running torque limit value to the second hydraulic cylinder required rotation speed. Therefore, in a case where the output torque of the electric motor 18 shifts toward the power running side as the load becomes lighter, when the operations of the second operating portions 73 are simultaneously performed, the motor control unit 65 controls the electric motor 18 to rotate at a rotation speed based on the power running torque limit value and to rotate at the rotation speed of the required lower limit for operating the second hydraulic cylinders 70, thereby suppressing the power consumption. From the above description, the regeneration efficiency in a case where a load is heavy can be improved, and the power consumption in a case where a load is lightweight can be suppressed. That is, the regeneration efficiency can be improved by suppressing the pressure loss of the hydraulic oil, and the power consumption can also be suppressed.

In addition, in the hydraulic driving device 16 for the cargo handling vehicle 1 according to this embodiment, in a case where the second hydraulic cylinders 70 includes a plurality of hydraulic cylinders and the determination unit 69 determines that the operations of the second operating portions 73 including the lowering operation of the lift operating lever 11 are simultaneously performed, the motor command rotation speed calculation unit 67 may set the rotation speed command value to a maximum value from between the required rotation speeds of the plurality of hydraulic cylinders, and the power running torque limit value calculation unit 68 may set the power running torque limit value to maximum value from between the required rotation speeds of the plurality of hydraulic cylinders. Accordingly, even in a case where the second hydraulic cylinders include the plurality of hydraulic cylinders, the regeneration efficiency in a case where a load is heavy can be improved, and the power consumption in a case where a load is lightweight can he suppressed. That is, the regeneration efficiency can be improved by suppressing the pressure loss of the hydraulic oil, and the power consumption can also be suppressed.

In addition, the hydraulic driving device 16 for the cargo handling vehicle 1 according to this embodiment includes the hydraulic pipe 49 that connects the branch point provided between the solenoid proportional valve 48 in the hydraulic pipe 47 and the suction port 17a of the hydraulic pump motor 17 to the tank 19, and the pressure compensation valve 50 provided in the hydraulic pipe 49. By controlling the electric motor 18 to rotate at a rotation speed based on the power running torque limit value, in a case where driving based on the rotation speed command value cannot be achieved, the pressure compensation valve 50 may discharge the hydraulic oil to the tank 19 via the hydraulic pipe 49. Accordingly, unnecessary hydraulic oil can be returned to the tank 19.

While several preferred embodiments of the hydraulic driving device for the cargo handling vehicle according to the present invention have been described above, the present invention is not limited to the embodiments.

In the embodiments described above, as the second hydraulic cylinders, the tilt cylinder, the PS cylinder, and the attachment cylinder are provided. However, at least one second hydraulic cylinder may be provided, and some of the second hydraulic cylinders may be omitted. For example, in the embodiments, the attachment and the power steering are mounted. However, the hydraulic driving device of the present invention can he applied to a forklift in which an attachment and a power steering are not mounted. In addition, the hydraulic driving device of the present invention can also be applied to any battery type cargo handling vehicle other than a forklift.

The control valve that controls the flow of the hydraulic oil based on the lowering operation of the lift operating lever and the control valve that controls the flow of the hydraulic oil based on the operations of the second operating portions are exemplified by the solenoid proportional valves, but may also be of a hydraulic type or a mechanical type.

### REFERENCE SIGNS LIST

1 . . . cargo handling vehicle, 4 . . . lift cylinder (first hydraulic cylinder), 4b . . . bottom chamber, 6 . . . fork (object), 9 . . . tilt cylinder (second hydraulic cylinder), 11 . . . lift operating lever (first operating portion), 12 . . . tilt operating lever (second operating portion), 13 . . . steering (second operating portion), 14 . . . PS cylinder, 15 . . . attachment cylinder (second hydraulic cylinder), 16 . . . hydraulic driving device, 17 . . . hydraulic pump motor (hydraulic pump), 17a . . . suction port, 17b . . . discharge port, 18 . . . electric motor (motor), 26, 31, 36 . . . solenoid proportional valve (second control valve), 47 . . . hydraulic pipe (lowering oil passage), 48 . . . lift lowering solenoid proportional valve (first control valve), 49 . . . hydraulic pipe (bypass oil passage), 50 . . . pressure compensation valve (flow rate control valve), 60 . . . controller, 64 . . . output torque determination unit (control unit), 65 . . . motor control unit (control unit), 67 . . . motor command rotation speed calculation unit (rotation speed command value setting unit), 68 . . . power running torque limit value calculation unit (power running torque limit value setting unit), 69 . . . determination unit, 70 . . . second hydraulic cylinder, 72 . . . second control valve, 73 . . . second operating portion.

1. A hydraulic driving device for a cargo handling vehicle comprising:
a first hydraulic cylinder for use in raising and lowering that raises and lowers an object by supplying and discharging a hydraulic oil;
a second hydraulic cylinder that performs a different operation from the first hydraulic cylinder by supplying and discharging the hydraulic oil;
a first operating portion for operating the first hydraulic cylinder;
a second operating portion for operating the second hydraulic cylinder;
a hydraulic pump that performs supply and discharge of the hydraulic oil with respect to the first hydraulic cylinder and the second hydraulic cylinder;
an electric motor that is connected to the hydraulic pump and functions as a motor or a generator;
a control unit that controls driving of the electric motor;
a lowering oil passage that connects a bottom chamber of the first hydraulic cylinder to a suction port of the hydraulic pump so as to cause the hydraulic oil discharged from the first hydraulic cylinder to the suction port of the hydraulic pump;
a first control valve that is disposed in the lowering oil passage and controls a flow of the hydraulic oil discharged from the first hydraulic cylinder based on a lowering operation of the first operating portion;
a second control valve that is disposed on a pipe that connects a discharge port of the hydraulic pump to the second hydraulic cylinder and controls the flow of the hydraulic oil based on an operation of the second operating portion;
a rotation speed command value setting unit that sets a rotation speed command value of the electric motor;
a power running torque limit value setting unit that sets a power running torque limit value of the electric motor; and
a determination unit that determines whether or not the lowering operation of the first operating portion is independently performed and whether or not the operation of the second operating portion including the lowering operation of the first operating portion is simultaneously performed,
wherein, in a case where the determination unit determines that the lowering operation of the first operating portion is independently performed, the rotation speed command value setting unit sets the rotation speed command value to a lowering required rotation speed based on an operation amount of the first operating portion, and the power running torque limit value setting unit sets the power running torque limit value to a minimum rotation speed set in advance,
in a case where the determination unit determines that the operations of the second operating portion including the lowering operation of the first operating portion are simultaneously performed, the rotation speed command value setting unit sets the rotation speed command value to a maximum value from between the lowering required rotation speed based on the operation amount of the first operating portion and a second hydraulic cylinder required rotation speed based on an operation amount of the second operating portion, and the power running torque limit value setting unit sets the power running torque limit value to the second hydraulic cylinder required rotation speed based on the operation amount of the second operating portion, and
the control unit controls the electric motor to rotate at a rotation speed based on the rotation speed command value and controls the electric motor to rotate at a rotation speed based on the power running torque limit value in a case where an output torque of the electric motor shifts toward a power running side.

2. The hydraulic driving device for a cargo handling vehicle according to claim 1,
wherein the second hydraulic cylinder includes a plurality of hydraulic cylinders, and
in a case where the determination unit determines that the operation of the second operating portion including the lowering operation of the first operating portion is simultaneously performed, the rotation speed command value setting unit sets the rotation speed command value to a maximum value from between the lowering required rotation speed and required rotation speeds for the plurality of hydraulic cylinders of the second hydraulic cylinder, and the power running torque limit value setting unit sets the power running torque limit value to the maximum value from between the required rotation speeds for the plurality of hydraulic cylinders of the second hydraulic cylinder.

3. The hydraulic driving device for a cargo handling vehicle according to claim 1, further comprising:
a bypass oil passage that connects a branch point between the first control valve in the lowering oil passage and the suction port of the hydraulic pump to a tank; and
a flow rate control valve provided in the bypass oil passage,
wherein, by controlling the electric motor to rotate at a rotation speed based on the power running torque limit value, in a case where driving based on the rotation speed command value is not able to be achieved, the flow rate control valve discharges the hydraulic oil to the tank via the bypass oil passage.
